(19) United States
(12) Patent Application Publication
(10) Pub. No.: US 2006/0093030 A1
(43) Pub. Date: May 4, 2006

(54) Method for compressing digital data of a video sequence comprising alternated shots

(76) Inventors: Edouard Francois, Bourg Des Comptes (FR); Dominique Thoreau, Cesson Sevigne (FR); Jean Kypreos, Betton (FR)

Correspondence Address: THOMSON LICENSING INC., PATENT OPERATIONS, PO BOX 5312, PRINCETON, NJ, 08543-5312, US

(21) Appl. No.: 10/522,521

(22) PCT Filed: Jul. 23, 2003
(86) PCT No.: PCT/EP03/50331

§ 371 Date: Jan. 27, 2005

(30) Foreign Application Priority Data
Jul. 30, 2002 (FR) 0209639

(51) Int. Cl. H04N 11/04; H04N 11/02; H04N 7/12; H04B 1/66

(52) U.S. Cl. 375/240.01

(57) ABSTRACT

The process is characterized in that it comprises the following steps: segmentation of the sequence into alternating video shots, classification of these shots according to camera angles in order to obtain classes, construction of a sprite or video object plane for a class that is an image corresponding to the background relating to this class, grouping of at least two sprites onto the same sprite or video object plane, in order to form an image called large sprite, extraction, for the shots corresponding to the large sprite, of image foreground objects from the sequence relating to these shots, separate encoding of the large sprite and of the extracted foreground objects. Application to the transmission and to the storage of video data.

The invention relates to a process for the compression of digital data of a video sequence composed of alternating shots, with the use of “sprites”, and to a device for its implementation. It falls into the general context of video compression and, in particular, into that of the MPEG-4 video standard.

The term “sprite” is defined, for example within the MPEG-4 standard, as a video object plane (or VOP) that is generally of a larger size than the video being displayed and that persists for a certain time. It is used for representing more or less static regions, such as backgrounds, and is encoded using a partitioning into macroblocks. By the transmission of a sprite representing the panoramic background and by the encoding of the displacement parameters describing the movement of the camera, parameters representing, for example, the tapered transform of the sprite, it is possible to reconstruct consecutive images of a sequence from this single sprite.

The invention relates especially to video sequences comprising a succession of shots generated alternately from similar camera angles. This may, for example, be an interview sequence, where the interviewer and the interviewee are seen alternately, each against a different—but for the most part static—background. This alternation is not limited to two different camera angles. The sequence can be composed of N shots, resulting from Q different camera angles.

The encoding techniques of conventional type do not take into account this type of sequence and the encoding cost or the compression factor is therefore equivalent to that of other sequences. Indeed, the conventional approach consists in, at each shot beginning, encoding an image in intra mode which is directly followed by images in predictive mode. If a shot taken from a first camera angle appears a first time, followed by a shot taken from another camera angle, followed by a shot taken from the first camera angle, then the first image of this shot is encoded entirely in intra mode even if a large part, formed by the background of the scene being filmed, is similar to the images of the first shot. This leads to a high encoding cost.

A known solution to this problem of re-encoding of a background that has already been previously shown consists in, each time a change of shot is detected, storing the last image of a shot. At the beginning of a new shot, the first image is encoded by time prediction having as reference, from the stored images, the one that most resembles it and that therefore corresponds to the same camera angle. Such a solution can be considered as being directly inspired by a tool known as “multi-frame referencing”, available for example in the standard MPEG-4 part 10 which is under development. Such a solution is, however, memory hungry, difficult to implement and costly.

The invention aims to overcome the aforementioned drawbacks. A subject of the invention is a process for the compression of digital data of a video sequence, characterized in that it comprises the following steps:

segmentation of the sequence into alternating video shots,

classification of these shots according to camera angles in order to obtain classes,

construction of a sprite or video object plane for a class that is a composite image corresponding to the background relating to this class,

grouping of at least two sprites onto the same sprite or video object plane, in order to form an image called large sprite,

extraction, for the shots corresponding to the large sprite, of image foreground objects from the sequence relating to these shots,

separate encoding of the large sprite and of the extracted foreground objects.

According to a particular embodiment, the sprites are placed one under the other in order to construct the large sprite.

According to a particular embodiment, the positioning of the sprites is calculated as a function of the cost of encoding of the large sprite.

The encoding exploited is, for example, the MPEG-4 encoding, the large sprite then being encoded according to the sprites defined in the MPEG-4 standard.

According to a particular embodiment, the process performs a multiplexing operation (8) for the data relating to the extracted foreground objects and for the data relating to the large sprite in order to deliver a data stream.

Another subject of the invention is the compressed data stream for the encoding of a sequence of images according to the process described previously, characterized in that it comprises encoding data for the large sprite associated with deformation parameters applicable to the large sprite and encoding data for the extracted foreground objects.

Another subject of the invention is an encoder for encoding data according to the process described previously, characterized in that it comprises a processing circuit for the classification of the sequences into shots, the construction of a sprite for each class and the composition of a large sprite by concatenation of these sprites, a circuit for the extraction of image foreground objects from the sequence relating to the large sprite and an encoding circuit for the encoding of the large sprite and the extracted foreground objects.

Another subject of the invention is a decoder for the decoding of video data of a video sequence comprising alternating shots according to the process described previously, characterized in that it comprises a decoding circuit for data relating to a large sprite and for data relating to foreground objects and a circuit for constructing images from the decoded data.

The sprite is used in order to describe the background of the set of video shots produced by the same camera angle. This sprite is encoded only once. Then, for each image of these video shots, the process consists in encoding the deformation parameters to be applied to the sprite in order to reconstruct what is visible of the background in the image. As regards the background objects, these are encoded as non-rectangular video objects or VOPs (Video Object Planes). On decoding, these VOPs are composed with the background in order to obtain the final image. Since the sequence comprises shots produced from several camera angles, several sprites are required. A particular embodiment of the invention consists in concatenating these various sprites into a single large sprite that then summarizes the various backgrounds of the complete video sequence.

Thanks to the invention, the re-encoding of the background at each re-appearance of this background is avoided. The cost of compression of this type of video sequence is reduced relative to a conventional encoding scheme of the MPEG-2 or H.263 type.

Other features and advantages will become clearly apparent in the following description presented by way of non-limiting example and with regard to the appended figures that show:

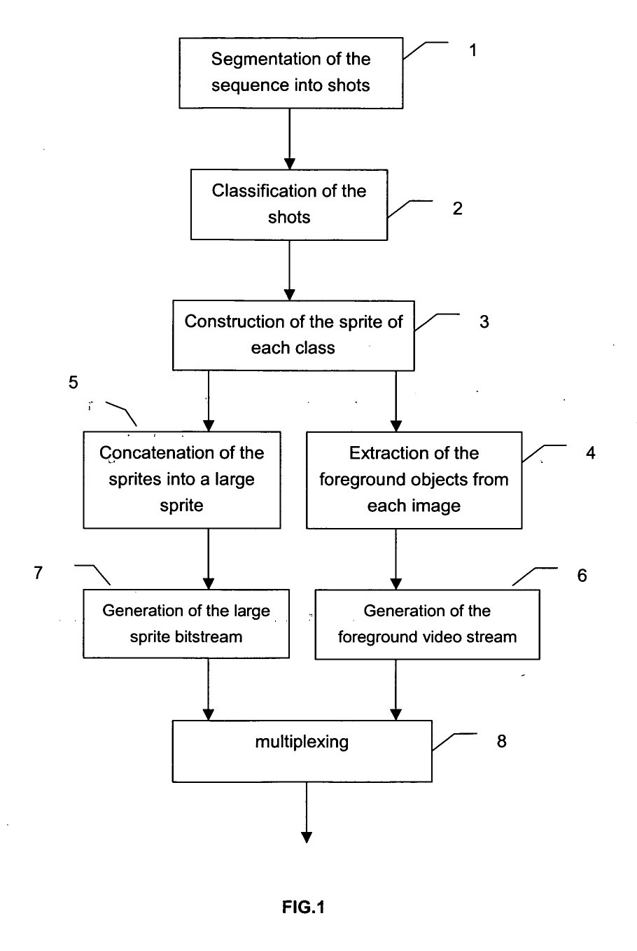

FIG. 1, a flow diagram of an encoding process according to the invention;

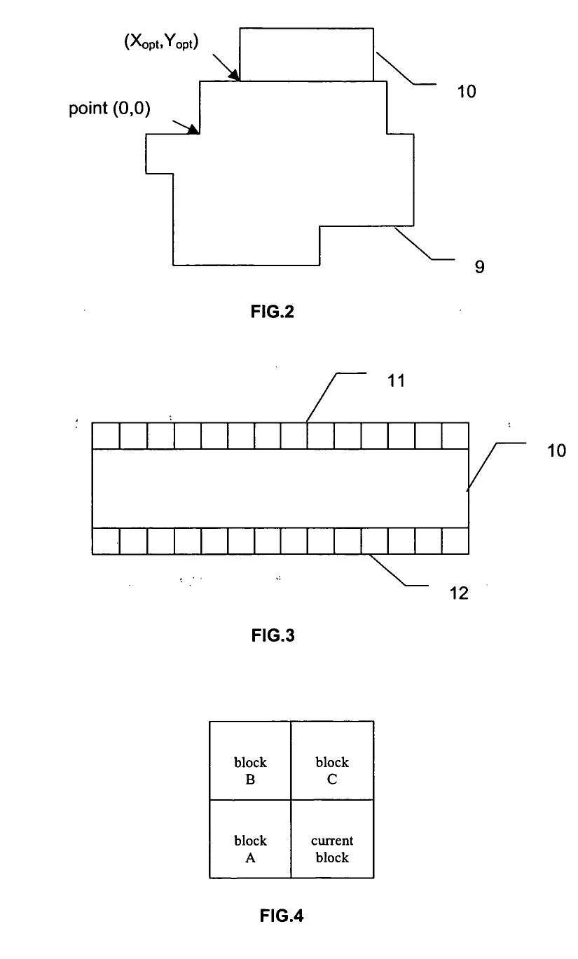

FIG. 2, the integration of a sprite within a large sprite;

FIG. 3, blocks of a sprite at the top and bottom edges of a large sprite; and

FIG. 4, a current block in its environment for encoding by DC/AC prediction.

FIG. 1 shows a simplified flow diagram of an encoding process according to the invention. This process can be divided into two main phases: an analysis phase and an encoding phase.

The analysis phase comprises a first step 1 that is a step for segmenting the video sequence into shots. A second step 2 performs a classification of the shots according to the camera angle from which they are produced. A class is defined as a subset of shots produced from the same camera angle. The third step carries out, for each of the subsets, the construction of a sprite “summarizing” the background visible in the shots of the subset. For each image of each shot of the subset, deformation parameters are also calculated that allow what is visible of the background to be reconstructed from the sprite. An image sementation step 4 carries out a segmentation for each image of the various shots, the purpose of the segmentation being to distinguish the background from the foreground. This step allows foreground objects to be extracted from each image. Step 5, which is carried out in parallel with step 4 and therefore directly follows step 3, consists of a concatenation of the various sprites into a single large sprite, with an update of the deformation parameters taking into account the position of each sprite within the large sprite.

The encoding phase directly follows the analysis phase. Steps 6 and 7 directly follow, respectively, steps 4 and 5 and generate a video bitstream encoding the foreground and a video bitstream encoding the large sprite, respectively. These bitstreams are then multiplexed in step 8 in order to deliver the video-encoding stream.

Step 1 for segmentation into shots divides up the sequence into video shots by comparing the successive images, for example by exploiting an algorithm for detecting a change of shots. The classification step 2 compares, according to their contents, the various shots obtained and groups similar shots, in other words shots produced from an identical or almost identical camera angle, into the same class.

Step 4 implements an extraction of the foreground objects. Successive binary masks are calculated that distinguish, for each image of the video sequence, the background and foreground. Following this step 4, a succession of masks, binary or otherwise, are therefore available, for each shot, that indicate the parts from the foreground and from the background. In the case of a non-binary processing, the mask in fact corresponds to a grey-shape card.

The concatenation of the sprites into a large sprite carried out in step 5 can be achieved in such a way that the encoding cost of this large sprite is minimized as is proposed above. The encoding information is, amongst other things, information on texture and information on deformation. The latter information is, for example, the successive deformation parameters which can be applied to the large sprite, as a function of time, and which are updated when the large sprite is generated. Indeed, it is these transformation parameters which, when applied to the large sprite, will allow the backdrops required for the various shots to be constructed and updated. This encoding information is transmitted in step 7 in order to allow the large sprite bitstream to be generated.

Here, two bitstreams are generated, one encoding the large sprite and the other encoding all the objects of the foreground grouped into a single object. These bitstreams are then multiplexed in step 8. In the MPEG-4 standard, an elementary stream per object is generated. It can therefore just as easily be envisaged to transmit several elementary streams or to omit a multiplexing with the stream relating to the large sprite for the transmission of the encoded data.

It will be noted that the object extraction step 4 is in fact very correlated with the preceding sprite construction step, so that it can be carried out simultaneously with, or even prior to, the preceding step. Likewise, the operations in steps 5 and 7, which are described in parallel with the operations in steps 4 and 6, can be carried out successively or prior to these steps 4 and 6. Furthermore, some of the analysis steps, for example that for extracting the objects, may be avoided in the case where a contents description of the MPEG-7 type is available for the video document to be encoded.

As indicated previously, the concatenation can be applied with the minimizing of the cost of encoding the large sprite in mind. The scope of this is three-fold: the texture, the shape, if it exists, and the successive deformation parameters. However, the main criterion is the cost of encoding the texture.

A method for minimizing this cost is presented below in an embodiment exploiting the MPEG-4 standard and carrying out an assembly of the sprites in a simple manner, in other words by horizontally stacking them, a method that relies on the operation of the MPEG-4 spatial prediction tool DC/AC. In the framework of the MPEG-4 standard, spatial prediction is carried out either horizontally or vertically. It, is applied, in a systematic fashion, to the first DCT coefficient of each block (DC prediction mode) and may also, optionally, be applied to the other DCT coefficients of the first row or first column of each block (AC prediction mode). The idea is to determine the optimal position for concatenation, in other words to search for the minimum texture encoding cost by assembling neighbouring sprites that have a continuity of texture on their common edges.

The large sprite is initialized by the widest sprite. Then, a new large sprite is calculated that integrates the widest sprite from amongst the remaining sprites, in other words the second widest sprite. FIG. 2 shows a large sprite 9 and a second large sprite 10 to be integrated in order to obtain the new large sprite, in other words to be positioned with respect to the sprite 9.

FIG. 3 shows the rectangular sprite 10 and, more especially, the succession of macroblocks 11 along the top edge and the succession of macroblocks 12 along the bottom edge of the sprite. The macroblocks of the sprite taken into account are the non-empty macroblocks adjacent to the top edge when the sprite is placed underneath the large sprite then to the bottom edge when the sprite is placed above the large sprite. In the case where the sprite is not rectangular, only the non-empty macroblocks at the top and bottom edge of the rectangle encompassing this sprite are taken into account. The empty macroblocks are ignored.

A discrete cosine transformation (DCT) is carried out on the macroblocks taken into account (or luminance blocks of the macroblocks), in other words the non-empty macroblocks or blocks along the top and bottom edges of the various sprites. The optimal top and bottom positions are then calculated by minimizing a continuity criterion for the textures at the interface of the two sprites.

For a given position (X, Y), defined by the coordinates (X, Y), of the sprite 10 to be integrated into the large sprite 9 previously calculated, a value of a global criterion C(X, Y) is calculated. The positions (X, Y) are, for example, the coordinates of the lower left corner of the upper sprite to be integrated or the coordinates of the upper left corner of the lower sprite to be integrated, the origin being defined from a predetermined point of the large sprite. The coordinates (X, Y) are limited in that the sprite is not allowed to extend outside of the large sprite.

For this given position (X, Y) and for all the positions tested, there will be N neighbouring blocks with the large sprite, situated either above or below it. Of these 2 rows of neighbouring blocks, in other words that belonging to the large sprite and that belonging to the sprite to be integrated, the row of the N bottom blocks will be considered. For each block Bₖ of these N blocks, what will be the probable direction of the DC/AC prediction is firstly determined.

FIG. 4 shows a current block and the surrounding blocks, block A to its left, block B above A and block C above the current block. As is done by a conventional DC/AC spatial prediction tool, the gradients of the DC coefficients between the blocks A and B, |DC_{A}−DC_{B}|, and between the blocks C and B, |DC_{C}−DC_{B}|, are determined. If there is no neighbouring block A, B or C, the DC coefficient is taken by default to be equal to 1024.

If |DC_{A}−DC_{B}|<|DC_{C}−DC_{B}|, the DC/AC prediction will probably be carried out in the vertical direction. For the current block, the residue of its first row corresponding to the vertical prediction will therefore be determined from the first row of the upper block C.

If |DC_{A}−DC_{B}|≧|DC_{C}−DC_{B}|, the DC/AC prediction will probably be carried out in the horizontal direction. For the current block, the residue of its first column corresponding to the horizontal prediction will therefore be determined from the first column of the left-hand block A.

Then, the energy of the residual AC coefficients is calculated, in other words with prediction of the first row or first column, according to the probable direction of prediction:

$${E}_{AC\_pred} = {\sum }_{i = 1}^{7} {( Δ {AC}_{i} )}^{2}$$

ΔACᵢ corresponding to the residue, in other words to the difference between the 7 AC coefficients of the first row or first column of the current block and the 7 AC coefficients, respectively, of the first row or column of the upper block or of the block to the left of the current block.

The energy of the initial AC coefficients, in other words before prediction, is also calculated:

$${E}_{AC\_init} = {\sum }_{i = 1}^{7} {AC}_{i}^{2}$$

ACᵢ corresponding to the 7 coefficients AC of the first row or the first column of the current block.

It is desired to determine the position, for a current block, that allows the energy to be as low as possible. The energy, for the part that varies according to the position of the block, depends on ΔDC, and possibly on the ΔACs where there is prediction. It is equal to:
when there is DC/AC prediction, in other words if E_{AC}_{_{—}}_{pred}<E_{AC}_{_{—}}ᵢₙᵢₜ,:

$$E ( {B}_{k} ) = Δ {DC}^{2} + {\sum }_{i = 1}^{7} {( Δ A {C}_{i} )}^{2}$$
when there is no DC/AC prediction, in other words if E_{AC}_{_{—}}_{pred}≧E_{AC}_{_{—}}ᵢₙᵢₜ,:
   E(Bₖ)=ΔDC²

The calculation is carried out for each of the N blocks of the row and the criterion C, for a given position, is then equal to:

$$C ( X , Y ) = {\sum }_{k = 1}^{N} E ( {B}_{k} )$$

The optimal position (Xₒₚₜ, Yₒₚₜ) is that which minimizes C(X, Y) over all of the positions tested.

Once the sprite to be integrated and its position in the large sprite have been determined, the deformation parameters of the sprite to be integrated are updated. For this purpose, the coordinates (Xₒₚₜ, Yₒₚₜ) of the point from which the new sprite is integrated into the large sprite are added to the translational component of its deformation parameters. In the case of a tapered model, there are 6 deformation parameters (a, b, c, d, e, f) of which 2, a and b, characterize the translational component or constant of the deformation. Therefore, a must be transformed into a+Xₒₚₜ, and b into b+Yₒₚₜ.

The new deformation parameters are inserted into the list of the deformation parameters of the large sprite, at the place where, temporally, the corresponding shot is inserted into the video sequence.

The result of the concatenation is as follows:

a large sprite instead of several sprites

a single list of deformation parameters, instead of 10 several lists corresponding to the various shots of the video sequence.

The successive deformation parameters allow what is visible in the background to be reconstructed, for each image of the video sequence, from the large sprite.

The encoding may be achieved by carrying out a pre-analysis step for the video sequence followed by an encoding step relying on this analysis.

In the specific case of the MPEG-4 standard, the encoding consists in generating a bitstream by using the sprite encoding tool (c.f. part 7.8 of the document ISO/IEC JTC 1/SC 29/WG 11 N 2502, p. 189 to 195). The second bitstream is based on the encoding tools for non-rectangular objects, in particular the encoding tool for the binary form (c.f. part 7.5 of the document ISO/IEC JTC 1/SC 29/WG 11 N 2502, p. 147 to 158) and, in addition, the grey-shape encoding tool (c.f. part 7.5.4 of the document ISO/IEC JTC 1/SC 29/WG 11 N 2502, p. 160-162) if the masks are not binary.

Another subject of the invention is the compressed data stream resulting from the encoding of a sequence of images according to the process previously described. This stream comprises encoding data for the large sprite associated with deformation parameters applicable to the large sprite and encoding data for the objects of the foregrounds for the reconstruction of the scenes.

Another subject of the invention is the encoders and decoders exploiting such a process. It relates, for example, to an encoder comprising a processing circuit for the classification of the sequences into shots, the construction of a sprite for each class and the composition of a large sprite by concatenating these sprites. It also relates to a decoder comprising a circuit for constructing images of alternating shots of a video sequence from the decoding of large sprites and foreground objects.

The applications of the invention relate to the transmission and the storage of digital images using video-encoding standards, especially the MPEG4 standard, with exploitation of sprites.

1. Process for compression of digital data of a video sequence, comprising the following steps:
segmentation of the sequence into alternating video shots,
classification of these shots according to camera angles in order to obtain classes,
construction of a sprite or video object plane for a class that is a composite image corresponding to the background relating to this class,
grouping of at least two sprites onto the same sprite or video object plane, in order to form an image called large sprite,
extraction, for the shots corresponding to the large sprite, of image foreground objects from the sequence relating to these shots,
separate encoding of the large sprite and of the extracted foreground objects.

2. Process according to claim 1, wherein the sprites are placed one under the other in order to construct the large sprite.

3. Process according to claim 2, wherein the positioning of the sprites is calculated as a function of the cost of encoding of the large sprite.

4. Process according to claim 1, wherein the large sprite is a sprite such as is defined and encoded in the MPEG4 standard.

5. Process according to claim 1, wherein a multiplexing operation is carried out for the data relating to the extracted foreground objects and for the data relating to the large sprite in order to deliver a data stream.

6. Compressed data stream for the encoding of a sequence of images according to the process of claim 1, comprising encoding data for the large sprite associated with deformation parameters applicable to the large sprite and encoding data for the extracted foreground objects.

7. Encoder for encoding data according to the process of claim 1, comprising a processing circuit for the classification of the sequences into shots, the construction of a sprite for each class and the composition of a large sprite by concatenation of these sprites, a circuit for the extraction of image foreground objects from the sequence relating to the large sprite and an encoding circuit for the encoding of the large sprite and the extracted foreground objects.

8. Decoder for the decoding of video data of a video sequence comprising alternating shots according to the process of claim 1, further comprising a decoding circuit for data relating to a large sprite and for data relating to foreground objects and a circuit for constructing images from the decoded data.
